(19) United States
(12) Patent Application Publication
(10) Pub. No.: US 2025/0233417 A1
(43) Pub. Date: Jul. 17, 2025

(54) CONNECTED ENERGY STORAGE, ELEVATOR SYSTEM AND METHODS

(71) Applicant: Inventio AG, Hergiswil (CH)

(72) Inventor: Philippe Henneau, Zurich (CH)

(21) Appl. No.: 18/856,641

(22) PCT Filed: Apr. 19, 2023
(86) PCT No.: PCT/EP2023/060113

§ 371 Date: Oct. 14, 2024

(30) Foreign Application Priority Data
Apr. 20, 2022 (EP) 22169102.5

(51) Int. Cl. H02J 3/28; B66B 1/28; H02J 3/00

(52) U.S. Cl. CPC H02J 3/28; B66B 1/28; H02J 3/004; H02J 2310/12

(57) ABSTRACT

A connected energy storage element powers an electrical subsystem of an elevator system. The connected energy storage element includes an energy storage element and a communication element, wherein the connected energy storage element is connected to an external electrical energy feed and to an electrical subsystem of the elevator system. The communication element receives information and/or instructions for controlling whether the electrical subsystem is to be powered by the external electrical energy feed or by the energy storage element or both, and/or for controlling the charging of the energy storage element by the external electrical energy feed. The connected energy storage element is arranged such that an elevator drive of the elevator system is not powerable by the energy storage element.

### FIELD

The present disclosure relates to elevator technology. In particular, the present disclosure relates to a connected energy storage for planning and scheduling of elevator energy demand. Further in particular, the present disclosure relates to a connected energy storage element for powering an electrical subsystem of an elevator system, an elevator system, an elevator installation, method of modernizing an elevator system and a method of operating an elevator system and/or an elevator installation.

### BACKGROUND

Elevator systems exist for more than 150 years now. An elevator is a vertical transport system that moves an elevator car between floors in a building, a vessel or the like. Two main ways of driving an elevator system, i.e., the elevator car within the shaft, have been realized, the traction type elevator and the hydraulic type elevator. Additionally, in the recent past, elevator systems with self-driving elevator cars have been developed, where the drive for moving the elevator car is mounted on the elevator car itself, so that the elevator car is more freely maneuverable within the elevator shaft.

A conventional elevator system comprises an elevator car and a counterweight, which are connected by a suspension and traction medium. In a traction type elevator, the suspension medium runs around a sheave connected to an elevator drive that is adapted to move the traction medium and thereby raises or lowers the elevator car and the counterweight. When the elevator car is raised, the counterweight is lowered at the same time, and vice versa. The counterweight is reducing a weight imbalance, thereby reducing the energy required to move the elevator car up and down in the elevator shaft. In a hydraulic elevator the elevator system employs either a hoist arrangement without a counterweight where a hydraulic cylinder attached to the car raises or lowers the car, or employs a counterweight connected to the car by the mean of a traction medium running around a pulley, which in turn is raised or lowered by a hydraulic cylinder. With this movement in connection to the hoist arrangement in the elevator shaft, the elevator car is raised or lowered.

Elevator systems, depending on their size and dimensions and applications and usage category, may be considered power hungry appliances, utilizing a significant amount of electrical energy in standby to ensure immediate availability when operation is demanded, and requiring even more electrical energy when in operation, i.e., when transporting passengers or goods up and down the elevator shaft.

In a typical elevator system, the energy demand of an elevator can be split in two components: the stand-by energy required to power the controller and components, which are active when the elevator is not travelling, and the energy required while travelling, mainly to power the elevator drive which lifts the load. The energy standards such as the VDI 4707 refers to the energy specific demand to depict the energy required to lift a given weight, typically 1 kg over 1 meter. In absolute value, the power required to travel is much higher than the stand-by power. By the way of an example, 50 W represent the stand-by power of a residential elevator while the power required by the same elevator to travel would be in the range well above 1 KW, typically between 3 KW/h and 10 KW/h, exemplarily around 5 KW/h for a residential elevator with a speed of 1 m/s and a load of 630 Kg.

While a temporary energy consumption of the elevator system is substantially higher when the elevator is in operation, the total amount of energy consumed by a residential elevator is a comparably small percentage of the total energy consumption of the elevator system. In other words, the majority of the energy consumed by the elevator system is the standby energy of the elevator system, i.e., the energy when the elevator car is not moving. In order to provide substantially instantaneous access to the transport functionality of the elevator system, all relevant electrical subsystems of elevator system need to be up and running, and thus powered by electrical energy. To provide this instantaneous access to the transport functionality, e.g., the elevator controller and further subsystems, like light subsystems and communication subsystems, need to be running, thereby consuming energy. Common elevator drives, e.g., electric, hydraulic or pneumatic elevator drives essentially do not consume any or at least only a negligible amount of energy when not in operation, thereby not contributing to the standby energy consumption system in any significant manner.

Considering the energy requirement of a common residential elevator system in a 24-hour window, it becomes clear that the energy required to provide the standby capability essentially corresponds to 80% to 90% of the total energy consumption of the elevator system. In other words, the energy required to power the elevator drive corresponds to only 5 to 10% of the total energy consumption of the elevator system. From this, it becomes clear that in order to reduce or balance demand on energy grid/power grid, it is more effective to provide alternative energy provisioning for the elevator system during standby time, i.e., the time where the elevator car is not moving, compared to the operating time, i.e., the time where the elevator car is close to or currently moving.

Thus, there may be a need for providing an option to adjust the power demand of the elevator system on the power grid during standby of the elevator system, thereby providing a balancing function for the power grid.

Further, there may be a need to provide alternative energy provisioning for the elevator system during standby.

Abandoned US20110208360A1 attempted to power the whole elevator, which makes planning of a required energy amount dependent of the usage of the elevator.

### SUMMARY

At least one such need may be met by the subject-matter of the preferred embodiments that are explained in detail in the following description.

According to a first aspect of the present disclosure, there is provided a connected energy storage element for powering an electrical subsystem of an elevator system, comprising an energy storage element, and a communication element, wherein the connected energy storage element is adapted to be connectable to an external electrical energy feed and to an electrical subsystem of an elevator system, and wherein the communication element is adapted to receive information and/or instructions for controlling whether the electrical subsystem is to be powered by the external electrical energy feed or the energy storage element or both, and/or controlling the charging of the energy storage element by the external electrical energy feed, and wherein the connected energy storage element is arranged such that an elevator drive of the elevator system is not powerable by the energy storage element and/or wherein the elevator drive is not connected to the connected energy storage element.

According to a second aspect of the present disclosure, there is provided an elevator system, comprising an elevator drive adapted to move an elevator car in an elevator shaft, an electrical subsystem adapted for operating and/or controlling the operation of at least a part of the elevator system and a connected energy storage element according to the present disclosure, wherein the electrical subsystem is adapted to be powered by at least one of an external electrical energy feed and the connected energy storage element.

According to a third aspect of the present disclosure, there is provided an elevator installation, wherein the elevator installation comprises a plurality of elevator systems according to the present disclosure, in particular a plurality of locally and/or geographically distributed elevator systems, further in particular arranged at a plurality of locally and/or geographically distributed operation locations, and wherein the energy demand of a least a subset of the plurality of elevator systems is adjustable based on the received instructions, wherein, based on the instructions, a current and/or future power consumption of the elevator system is adjustable, and/or wherein, by connecting an electrical subsystem to and/or disconnecting an electrical subsystem from the external electrical energy feed a current and/or future power consumption of the elevator system is adjustable.

According to a fourth aspect of the present disclosure, there is provided a method of modernizing an elevator system, comprising adding a connected energy storage element according to present disclosure to an elevator system.

According to a fifth aspect of the present disclosure, there is provided a method of operating an elevator system and/or an elevator installation, comprising an elevator drive, an electrical subsystem, a connected energy storage element and a communication element, the method comprising receiving information or instructions via the communication element, and dependent on the received information or instructions controlling whether the electrical subsystem is to be powered by an external electrical energy feed or the energy storage element or both, and/or controlling the charging of the energy storage element by the external electrical energy feed, wherein the energy storage element is arranged such that the elevator drive is not powerable by the energy storage element.

The present disclosure provides a connected energy storage element, or a connected electrical energy storage element, arranged within the elevator system and adapted to power at least one electrical subsystem of the elevator system. Preferably, the electrical subsystem is a subsystem that is required to provide substantially instantaneous access to the operation of the elevator system, like e.g., the elevator controller. It is specifically noted that the in context of this disclosure, the elevator drive is not considered an electrical subsystem in accordance with the present disclosure. In other words, the referred to electrical subsystem may be any electrical subsystem of the elevator except the elevator drive.

The power consumption of an electrical subsystem compared to the elevator drive may be considered almost constant over the time. Those electrical subsystems consume the same when the elevator car is traveling and when it is not traveling, thus in standby mode. This makes the electrical consumption of those electrical subsystems predictable, which allows to make correct planning of energy consumption taken from the external electrical feed. It must be noted that the power consumption of the elevator subsystems other than the drive is constant but is different for each type of elevator or elevator installation, depending on the elevator configuration, hence why the planning of the energy required is preferably done locally. Contrary hereto, the power consumption of the elevator drive is not constant, as it depends on load, direction and speed of travel and is therefore less predictable depending on the use and the user. The “constant” aspect of the energy consumption of electrical subsystems allows a correct dimensioning of the energy storage element of the connected energy storage element, so that the standby operation may be powered by the connected energy storage element in a reliable and predictable manner.

A connected energy storage element according to the present disclosure comprises an energy storage element like e.g., a rechargeable battery, a capacitive energy storage or the like. The connected energy storage element is arranged to receive electrical energy from the outside of the elevator system, e.g., via a common energy feed. The received energy may be used to charge the energy storage element and/or may be forwarded, alternatively or additionally, to at least one electrical subsystem, i.e., to consumers of the elevator system. The connected energy storage element may be arranged and/or dimensioned to provide the energy required by some or all of the electrical subsystems of the elevator system, except the elevator drive a defined, in particular prolonged period of time, in order to maintain the elevator standby without requiring any external energy, i.e., energy from outside of the elevator system.

Only when the elevator system is required to provide its transport functionality, i.e., when a user of the elevator system intends to use the elevator system to do an elevator trip does the elevator system require external energy, in particular for powering the elevator drive. By using the energy stored in the energy storage element over a period of time, the demand on the electrical grid can be reduced or relieved. In other words, the elevator drive is still powered from the electrical grid, while one, some or all of the electrical subsystems is/are powered from the energy storage element. This results in a reduced load on the energy grid compared to a situation where all elements of the elevator system, i.e., the elevator drive and all electrical subsystems, are powered directly from the electrical grid.

Since the total amount of energy required by the elevator system over an extended period of time is the energy required to provide the standby functionality, the burden on the electrical grid can be controlled and in particular steered to a significant extent. E.g., in case the energy storage element is arranged or dimensioned such that the energy required to provide 24 hours of standby operation can be provided by the energy storage element before requiring recharging, the energy grid is relieved accordingly. Within this defined time window, a preferred time for recharging the energy storage element may be determined, which may be a time where the demand on the energy grid is comparably small and/or where a surplus of energy is anticipated. In other words, the energy requirement of the elevator standby may be moved and in particular condensed or compressed in a defined time period or time window charging the energy storage element. Thus, the burden on the energy grid may be converted from a substantially constant 24-hour load to a (an increased) load over a significantly shortened period of charging time, that further be sent a suitable time during the overall time window where energy surpasses exists and/or where the overall demand on the energy is low. Alternatively, or additionally, this may coincide with a cost for the energy consumed, thereby reducing the total cost for operating the elevator system.

Since the energy storage element is a connected energy storage element in communicative connection with an external entity, the connected energy storage element is adapted to receive information and/or instructions from outside of the elevator system in order to control the functionality of the connected tree storage element. In other, the information and instructions received may inform or instruct the energy storage element about times during which the energy for the standby operation is to be taken from the grid or from the energy storage element. Likewise, the information or instructions may indicate to the connected energy storage element about times or time windows for charging the energy storage element.

Regardless of whether the standby operation of the elevator system is currently powered by the energy storage element or the energy grid and also regardless of whether the energy storage element of the connected energy storage element is currently charged, when a user is about to use the transport functionality of the elevator system, the energy required for operating the elevator drive is taken from the energy grid. Even then, the total instantaneous energy consumption for the transport operation, i.e., the elevator trip, can be reduced, since the energy required for operating some or all of the electrical subsystems of the elevator system can still be provided from the energy storage element, even though the elevator drive is powered by energy from the elevator grid.

In light of this functionality, the energy storage element of the connected energy storage element can be dimensioned such that the energy capacity is sufficient for powering the standby operation of the elevator system over a defined period of time, e.g., 12 or 24 hours, without the need to be dimensioned such that also the elevator drive could be operated through the energy storage element. This allows to dimension the energy storage element comparably small, and also dimension the instantaneous energy delivery capability thus small to only suffice for the standby operation.

Using the communication functionality of the connected energy storage element allows instructing the energy storage element to exhibit a defined behavior for a defined time future. In other words, not only can it be communicated to the connected energy storage element to reduce the energy burden on the grid at the time of the receival of the information and/or instructions, but also at a defined time or for a defined time period in the future, e.g., “in X hours”, “from XX:xx hours” or “between XX:xx and YY:yy hours”. In order to reduce the energy burden on the grid, the connected energy storage element may provide energy from its energy storage element to the respective electrical subsystems, thereby removing the need to power set subsystems through/from the grid.

The following scenarios may be differenced:

In case there is power from the external feed and the connected energy storage element is adapted to determine this:
1) The at least one electrical subsystem may be powered by the energy storage element if instructed so by an external control center. I.e., the connected energy storage element does not take energy from the external energy feed. Preferably, the energy storage may remain physically connected to the external energy feed but does not consume any external energy.
2) The at least one electrical subsystem is powered by the external feed and the connected energy storage element charges its energy storage element.

Of course, the connected energy storage element may power the at least one electrical subsystem from its energy storage element even when there is power from the external feed.

There is no power from the external feed:
1) “Mirror mode”: output of the connected energy storage element to one, select or all of the electrical subsystems may be turned off/disengaged independently of the level of stored energy. This mode may in particular be beneficial in a scenario where there is no sufficient energy to operate the elevator drive and the elevator controller is thus not provided with energy for its operation.
2) “Energy buffer mode”: the energy storage element may act as an emergency power supply and may power one, select or all of the electrical subsystems from its stored energy. This mode may in particular be beneficial for lighting associated with the elevator. In other words, even in case there is no external power, the lighting may be maintained. Alternatively, or additionally, in an elevator system that uses a pneumatic or hydraulic elevator drive, for such an elevator to drive downwards, e.g., for evacuation purposes, may simply require the controlled opening of a- hydraulic valve, since there is no need to power the elevator drive.

The present disclosure may be seen as providing a time shift of the energy demand from a time where taking energy from the grid may be less beneficial, e.g., due to high cost or low availability, to a time that is more beneficial, e.g., due to low cost, negative cost and/or high availability. The present connected energy storage element may provide, inter alia, such a functionality. This may be seen as being primarily driven by a need on the part of utility companies or energy providers for load balancing, since it may be expensive for a utility company or energy providers to repeatedly adjust the output of traditional power generation systems as the load varies. Energy storage may allow them to offset or delay the requirement of additional power plants, such as a gas-fired “Peaker” plants. In some markets, there may also be value for companies and people on the “other side of the meter” (i.e., the consumer of energy) to buy and store power when it is least expensive and use the stored power during peak demand when prices are highest. This may be referred to as “time shifting” of the energy demand or energy consumption.

The elevator system may be adapted to receive information and/or instructions to (temporarily) raise the energy consumption of the elevator system, at which time (or future time) the connected energy storage element may consume energy up to the limit of the external electrical feed of the elevator (e.g., defined by a fuse limit, the cross section of electrical cabling, etc.). In other words, power consumption of the elevator system may be raised to the limit of the nominal power the elevator has been designed for. E.g., the power taken from the external energy feed may substantially correspond to the maximum power delivery capability of the electrical installation (e.g., 16 A, 20 A or the like). This may be a scenario where there is a surplus of energy available via the external energy feed and the elevator system is consuming as much energy as possible by the local electrical installation, thereby providing a grid stabilizing functionality.

Alternatively, or additionally, the electrical energy storage element may increase the energy consumption of the elevator system to the maximum nominal energy delivery capability reduced by the energy required to operate the elevator drive. Thereby, the energy storage element of the connected energy storage element may be charged, and the consumption of the elevator system may be maximized while maintaining the capability to provide the transport functionality.

Still alternatively, an elevator system may comprise a plurality of connected energy storage elements. Each connected energy storage element may be connectable to a particular electrical subsystem or to a subgroup of electrical subsystems of the elevator system. Thereby, the total demand of the electrical subsystems may be shared by a plurality of connected energy storage elements, or only select electrical subsystems may be connected and or powered by one of the plurality of connected energy storage elements. E.g., it is conceivable to only connect the elevator controller to a particular connected energy storage element, so that the particular connected energy storage element is only responsible for the operation of the elevator controller. Alternatively, or additionally, the connectivity energy storage element may be connected to some or all of the electrical subsystems with the exception of the elevator controller (and the elevator drive). Thereby, when there is no external electrical energy feed, the elevator controller is automatically deactivated thereby avoiding a condition where there is no sufficient electrical energy to operate the elevator drive while at the same time the elevator controller is powered through a connected energy storage element. In this scenario, further electrical subsystems like e.g., lights, pneumatic valves for evacuation, etc., may still be powered by one or one of the plurality of connected energy storage elements.

According to an embodiment of the present disclosure, the elevator system may comprise at least one further electrical subsystem, wherein the at least one further electrical subsystem may be adapted to be powered by at least one of an external electrical energy feed and the energy storage element.

According to a further embodiment of the present disclosure, an electrical subsystem may be at least one out of the group consisting of an elevator controller, a light subsystem, a communications subsystem, an evacuation subsystem, an emergency communications subsystem, a door control subsystem, a door operations subsystem, sensor arrangement, elevator fixture, landing operation panel, car operation panel, safety circuit, a pneumatic element and a pneumatic valve.

With the option to power more than one electrical subsystem, i.e., a plurality or substantially all electrical subsystems of an elevator system except for the elevator drive, the burden on the grid at a specific time may be reduced further. In case substantially all electrical subsystems except for the elevator drive are connected to the connected energy storage element and potentially powerable through the connected energy storage element, thereby detachable or disconnectable from the energy grid, complete standby operation of the elevator system may be powerable by the connected energy storage element. In such a scenario, the elevator system is operating normally to a user and that a user can approach the elevator system at any desired time point and initiate its transport functionality, despite the fact that due to the powering of the electrical subsystems through the connected energy storage element, there is substantially no burden on the external energy grid. Only when the elevator system is about to commence the transport functionality, i.e., energy is required to operate the elevator drive, the additional energy may be taken from the energy grid.

In case of the elevator drive is an alternative elevator drive, e.g., a pneumatic elevator drive powered by a gas source arranged within the elevator system, e.g. a gas tank providing a suitable power source of compressed gas to the pneumatic elevator drive, the complete operation of the elevator system is grid independent as long as the energy stored in the connected energy storage element is sufficient to maintain the standby operation, or in other words provide sufficient energy to the electrical subsystems during the time of the standby operation. But also, during the time the elevator is providing its transport functionality, the electrical subsystems can be powered by the connected energy storage element from energy stored in the energy storage element.

In particular in case one of the electrical subsystems is one or more pneumatic valves, in particular in conjunction with a pneumatic elevator drive, the controlled opening and closing of pneumatic valves may provide an evacuation function for passengers trapped within the elevator car between floors. A controlled opening and closing of the at least one pneumatic valve may allow the controlled descent of the elevator car to an evacuation landing and/or to the next landing below the current position of the elevator car within the elevator shaft.

According to a further embodiment of the present disclosure, wherein the connected energy storage element may be adapted to determine whether the external electrical energy feed is sufficient to operate an elevator drive, and in case it is determined that the external electrical energy feed is insufficient to operate the elevator drive, the connected energy storage element may be adapted to inactivate the or an electrical subsystem, in particular the elevator controller, and/or wherein the connected energy storage element may be adapted to determine whether the external electrical energy feed is sufficient to operate the elevator drive, and in case it is determined that the external electrical energy feed is sufficient to operate the elevator drive, the connected energy storage element may be adapted to activate or keep activated the or an electrical subsystem, in particular the elevator controller, a light subsystem, a communications subsystem, an evacuation subsystem, an emergency communications subsystem, a door control subsystem, a door operations subsystem, sensor arrangement, elevator fixture, landing operation panel, car operation panel, safety circuit, a pneumatic element and a pneumatic valve.

The connected energy storage element and/or the elevator system in general is adapted to determine whether the external electrical energy feed is sufficient to operate the elevator drive, i.e., whether the external electrical energy feed is able to provide sufficient electrical energy to operate the elevator drive. The simplest situation may be that the connected energy storage element and/or the elevator system is a determining that the external electrical energy feed is inactive, e.g., due to an outage. In this case, since the connected energy storage element is only connected to and/or able to provide sufficient energy to power the electrical subsystems but not the elevator drive, certain measures may be beneficial to avoid that a user initiates the transport functionality of the elevator system or to avoid that after a (accidental) initiation of the transport functionality, e.g., the elevator controller is trying to initiate that transport functionality. Either case may result in a determination of a malfunction of the elevator system from the perspective of the elevator controller since the elevator controller while being powered through the connected energy storage element may not be able to determine and/or react appropriately. E.g., in case the connected energy storage element is retrofitted into an elevator system, e.g., in the course of a modernization of the elevator system, a situation may occur where the elevator controller is powered through the connected energy storage element, thereby assuming that sufficient electricity is provided by the external energy grid, since the elevator controller itself is powered, while indeed no or not sufficient electrical energy is available from the external electrical energy grid due to the aforementioned outage or a further malfunction. Since the elevator controller may not have been specifically designed to appropriately react to a situation where the elevator controller itself has sufficient energy for its operation but lacks sufficient energy for the operation of the elevator drive, such may result in an undefined operational state and potentially a hazardous situation, which could lead to a complete security shutdown of the elevator system as a reaction of the elevator controller to the undefined operational state.

In case of such a situation, it may be beneficial that the electrical subsystem, e.g., the elevator controller is inactivated so to avoid this undefined operational state. This inactivation may be simply not providing energy to the elevator controller from the connected energy storage element and/or alternatively appropriately signalling to the elevator controller to assume an inactive state. E.g., in case the elevator controller has a dedicated signal input for deactivation, the connected energy storage element may be adapted to signal to the elevator controller to assume the deactivated states, despite being provided with sufficient electrical energy. In other words, the inactivation may be a simple shutting off of the electrical subsystem, e.g., the elevator controller, i.e., not powering the electrical subsystem.

The determination may be implemented by determining directly by the connected energy storage element, e.g., by measuring the power delivery capability of external electrical energy feed, e.g., with a dummy load, a sensor, e.g. a voltage sensor, or the like, and/or whether there is any energy available from the external electrical energy feed, and/or may be implemented by receiving information and/or instructions from an external entity, which can be the same or a different external entity, whether the power delivery capability of external electrical energy feed is sufficient and/or whether there is any energy available from the external electrical energy feed.

According to a further embodiment of the present disclosure, the information and/or instructions may be received from an entity arranged external from the elevator system, in particular may be received from a power grid operating entity and/or a crowd balancing platform, and/or wherein the information and/or instructions are indicative of and/or dependent on a current energy cost, a current energy availability, an expected future energy cost, and/or an expected future energy availability, and/or wherein the information and/or instructions are instructing the connected energy storage element to perform a function at a defined time in the future and/or the connected energy storage element employs the information and/or instructions to perform a function at a defined time in the future.

According to a further embodiment of the present disclosure, wherein, based on the information and/or instructions, a current power consumption of at least a part of the elevator system may be adjustable, and/or wherein by controlling whether the electrical subsystem is to be powered by the external electrical energy feed or the energy storage element or both, and/or controlling the charging of the energy storage element by the external electrical energy feed a current power consumption of the elevator system may be adjustable.

As previously mentioned, the standby operation while at any given point in time only consuming a comparably small amount of energy, is responsible for most of the energy required by an elevator system. E.g., 80% or even 90% of the total energy consumption of an elevator system may be attributed to the standby energy. Being able to provide a steering functionality when this energy is taken from the grid allows a significant unloading of the electrical grid. In case of an energy storage element powering the elevator system during the standby operation, it is conceivable that the energy storage element itself is provided with the necessary energy to maintain the standby operation all over a substantially longer period of time in a comparably small period of time. In other words, the energy equalling the energy required for an extended standby operation may be provided to the energy storage element in a comparably short time by charging the energy storage element. It is thus conceivable that the energy storage element is charged for the duration of a few minutes to a few hours, while the thereby stored energy in the energy storage element is sufficient to maintain this standby operation for hours, days, weeks or possibly longer.

Since the charging requires significantly less time than the standby operation that can be maintained thereby, instructing the connected energy storage element to charge at a defined point in time allows coordination of the consumers connected to the energy grid and thereby provides a balancing functionality to the energy grid. E.g., during the day, the elevator system may use the energy stored in the energy storage element of the connected energy storage element to maintain the standby operation. During the night or a different off-peak time, the connected energy storage element may be instructed to recharge the energy storage element. Alternatively, or additionally, the connected energy storage elements may be instructed to recharge the energy storage element at a specific time where there is a surplus of energy.

Thereby, the burden of the elevator system on the energy grid by the standby operation may be reduced and may be shifted to a defined time where the charging of the energy storage element benefits the electrical grid, either by using an energy surplus or shifting the energy demand to an off-peak time, thus avoiding the grid energy suppliers to regulate the energy supply.

The instructions when to a not to draw energy from the energy grid for the standby operation may come from the energy grid, and energy provider associated with the energy grid and/or a crowd balancing platform. In particular a crowd balancing platform may be adapted to send according instructions to a plurality of energy consumers, e.g., a plurality of elevator systems or elevator installations, thereby balancing the demand on the energy grid by coordinating the energy demand from a plurality of energy consumers.

Additionally, all alternatively, the information provided to the elevator system and/or the connected energy storage element may comprise cost information, i.e., information on the current or future energy cost, so that the elevator system and/or the connected energy storage element itself may determine an appropriate point in time, possibly in the future, when to draw energy from the energy grid. E.g., during a high demand situation, it may be financially beneficial to not draw any energy from the energy grid, not only because potentially energy costs may be high, but also because potentially they may be a financial incentive for the operation of the elevator system to not draw any energy. Likewise, in a low demand situation or energy surplus situation, it may be beneficial for the operation of the elevator system to actually take energy from the grid, regardless of whether the energy is indeed needed to charge the energy storage element of the connected energy storage element. E.g., in an energy surplus situation, the energy cost could be significantly lower, could be zero or even negative. In other words, during and energy surplus situation, the charging of the energy storage element may even result in pay out despite actually using energy.

By determining of whether the standby operation of the elevator system is powered directly from the energy grid or via the energy storage element of the connected energy storage element, the energy consumption of the elevator system, seen by the energy grid, can be adjusted. In other words, by powering the standby operation from the energy storage elements, the energy consumption of the elevator system may be reduced, potentially to substantially zero (unless the transport functionality is demanded, which requires the powering of the elevator drive), while the energy consumption of the elevator system may be increased by powering the standby operation directly from the energy grid. The energy consumption may even be further increased by charging the energy storage element.

According to a further embodiment of the present disclosure, wherein the connected energy storage element may be adapted to report a current energy consumption, a future energy consumption, a current energy savings and/or a future energy savings to an entity arranged external from the elevator system, in particular a power grid operating entity and/or a crowd balancing platform.

An elevator system comprising a connected energy storage element according to the present disclosure may be indistinguishable from an elevator system not comprising the connected energy storage element when seen from the energy grid. In other words, the energy grid assumes the connection of an energy consumer without having a further knowledge about the operation of the energy consumer, e.g., the elevator system. In case the connected energy storage element provides the functionality of reducing an energy demand or increasing and energy demand in reaction to the received information and or instructions, the energy grid itself is regularly not capable of determining the impact that connected energy storage element has on the energy grid. Accordingly, the elevator system and/or the connected energy storage element provides information about its operation to the external entity. By providing that information, the external entity may determine the extent the elevator system and/or the connected energy storage element complied with the received information and or instructions in order to determine the balancing impact the behavior of the elevator system/the connected energy storage element had on the energy grid. E.g., in case the reduction of a potential energy demand or the increase of the energy demand in a surplus situation is compensated, financially or otherwise, such a reporting may be required in order for the operator of the elevator system to obtain the compensation stop.

According to a further embodiment of the present disclosure, wherein the external electrical energy feed may be one of a power grid feed, a single-phase electrical energy feed, a local electrical energy feed, a renewable energy powered energy feed and a mixture thereof.

Since the demand of the connected energy storage element may be comparably small when considering an instantaneous energy demand, a single-phase electrical energy feed may be sufficient to supply the connected energy storage element with the energy required to maintain standby operation of the elevator system and/or for charging the energy storage element of the connected energy storage element. The energy feed for the standby operation and/or the connected energy storage element may also be a local electrical energy feed, e.g., an energy feed powered by locally generated renewable energy, for example by a locally arranged wind turbine or solar cell system. In this case, the energy required for the standby operation may be exclusively generated independent of the energy grid. Locally generated energy may be stored in the energy storage element which may provide a buffer functionality for times when there is no local energy generation, e.g., during night or in case there is no wind. Thereby, the burden on the energy grid may be reduced even further, potentially to zero. It may be beneficial, even in the case of locally generated energy, to be able to still use energy from the energy grid, in case locally generated energy is not available for an extended period of time, in particular a time period that is too long for the energy storage element of the connected energy storage element to provide energy for the standby operation.

In case the transport function of the elevator system is to be activated, the energy required for operating the elevator drive may be provided by a further energy feed, e.g., a three-phase electrical energy feed. Thereby, the energy feed for the standby operation, including for powering and/or charging the connected energy storage element may be exclusively provided by one energy feed, e.g., the single-phase electrical energy feed, whereas the energy required by the elevator drive is provided by a different, separate energy feed.

According to a further embodiment of the present disclosure, the elevator drive may not be connected to the connected energy storage element, in particular to an outlet of the connected energy storage element or downstream (energy-wise) of the connected energy storage element and/or the elevator drive and the connected energy storage element may be connected to the external electrical feed in parallel. In other words, the connected energy storage element may not be able to power the elevator drive simply because it is not connected to the connected energy storage element. In a particular embodiment, the elevator drive may be connected to the power grid, and some or all electrical elevator subsystems are connected to the connected energy storage element. Thereby, the connected energy storage element may not only switch off or disconnect from power select or all electrical subsystems when there is no power from the grid, but also in a situation where grid power is still available but not to the extent to allow powering the elevator drive for a trip. Alternatively or additionally, the connected energy storage element may not only switch off or disconnect from power some or all electrical subsystems when the power of the grid is off or insufficiently available, but also in a situation where an external entity instructs the connected energy storage element to prevent a trip operation of the elevator drive, to reduce the electrical burden on the power grid.

This may also be seen as coordinating a plurality of elevator systems, to assure that not all elevator systems may be operated simultaneously, i.e., provide their transport functionality. E.g., in case the operation of a plurality of elevator systems of an elevator installation are to be coordinated, only a particular subset of the elevator systems of the elevator installation may be operated in parallel. This may mean that other elevator systems may temporarily be deactivated by the connected energy storage element or at least their operation prohibited. E.g., dependent on a particular implementation of an elevator controller, the power to the elevator controller may be interrupted by the connected energy storage element, and thus the elevator controller be powered off, or the elevator controller may simply receive a deactivation signal or cease operation signal from the connected energy storage element, to prevent operation of the elevator system without powering off the elevator controller. This may in particular be dependent on a type of elevator controller. E.g., older elevator controllers may be able to instantly resume operation when being powered on since all functionality is implemented in hardware, while newer elevator controller may require a dedicated operating system, and may thus require a particular start-up time, e.g., to boot the operating system or further software.

According to a further embodiment of the present disclosure, the method may further comprise receiving information or instructions via the communication element, and dependent on the received information or instructions controlling whether the electrical subsystem is to be powered by an external electrical energy feed or the energy storage element or both, and/or controlling the charging of the energy storage element by the external electrical energy feed, wherein the energy storage element may be arranged such that the elevator drive is not powerable by the energy storage element.

According to a further embodiment of the present disclosure, the method may further comprise determining whether the external electrical energy feed is sufficient to operate the elevator drive, and in case it is determined that the external electrical energy feed is insufficient to operate the elevator drive, inactivate the electrical subsystem, and/or determine whether the external electrical energy feed is sufficient to operate the elevator drive, and in case it is determined that the external electrical energy feed is sufficient to operate the elevator drive, activate or keep activated the electrical subsystem.

According to a further embodiment of the present disclosure, the method may further comprise report a current energy consumption, a future energy consumption, a current energy savings and/or a future energy savings to an entity arranged external from the elevator system, in particular to a power grid operating entity and/or to a crowd balancing platform.

According to a further embodiment of the present disclosure, wherein dependent on the received information and/or instructions, the electrical subsystem may be exclusively powered at a defined future point in time from the energy storage element, and/or may be charged at a defined future point in time the energy storage element.

### DESCRIPTION OF THE DRAWINGS

The present invention will now be described with reference to the accompanying drawings, in which:

FIG. 1 shows an elevator system according to the present disclosure.

FIGS. 2A to 2C show different connection scenarios of electrical systems within an elevator system according to the present disclosure.

FIGS. 3A to 3B show different installation scenarios of connected energy storage elements according to the present disclosure.

FIG. 4 shows a connected energy storage element according to the present disclosure.

### DETAILED DESCRIPTION

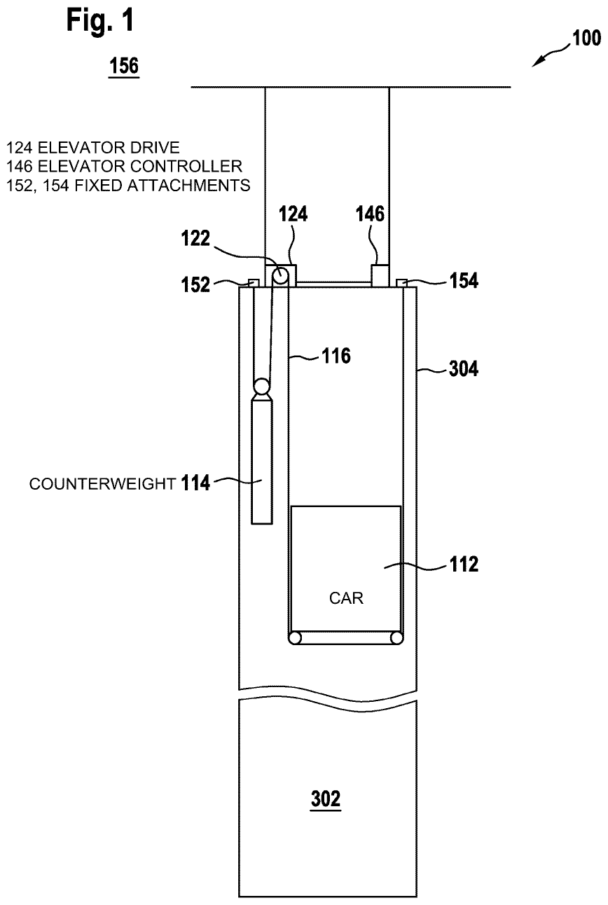

Now referring to FIG. 1, where an elevator system according to the present disclosure is depicted.

FIG. 1 shows an elevator system 100 where an elevator car 112 is arranged in an elevator shaft 302. The elevator car 112 is suspended within the elevator shaft 302 by a traction and suspension medium 116. The elevator car 112 in FIG. 1 is exemplarily arranged underslung by the traction medium 116. Further arranged in the elevator system 100 is counterweight 114, counterbalancing the weight of the elevator car 112. The traction medium 116 is fixed to the top of the elevator shaft by fixed attachments 152, 154. An elevator drive 124 is provided, exemplarily arranged at the top of the elevator shaft 302. Arranged at the elevator drive 124 is a traction sheave 122. The traction sheave 122 engages with the traction medium 116. The elevator drive 124 is arranged to actuate the traction sheave 122, thereby rotating the traction sheave 122. By the rotation of the traction sheave 122, the traction medium 116 is actuated so that the elevator car 112 can be raised or lowered within the elevator shaft 302 while at the same time the counterweight 114 is lowered or raised within the elevator shaft 302.

By actuation of the elevator drive 124, the elevator car 112 may first be moved up and down the elevator shaft 302 to realize the transport function of the elevator system 100. The elevator car 112 can stop at defined landings or floors of the building that the elevator system 100 is installed in, thereby providing the transport function by moving passengers and/or goods up and down the elevator shaft and between landings or floors at a wall 304 of the elevator shaft 302.

The elevator system 100 in FIG. 1 is employing an electrical elevator drive which is connected to the main power supply or external electrical feed 156. Additionally, the elevator system 100 comprises an elevator controller 146, also connected to the main power supply or external electrical feed 156. The elevator controller is adapted to receive control instructions, e.g., from a car operation panel or a floor operation panel, or in other words information on a desired trip that the elevator system should perform. By complying with the control instructions received as external input from a user while at the control panels or operation panel, not depicted in FIG. 1, the elevator system 100 is providing its transport function.

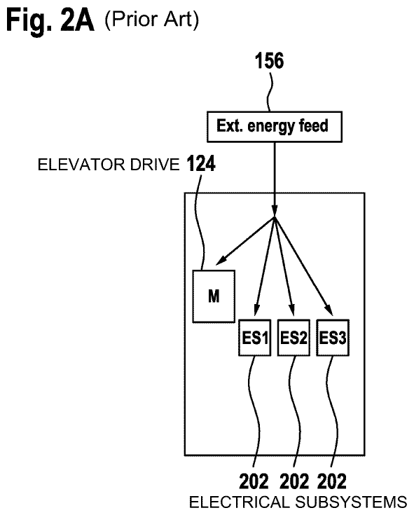

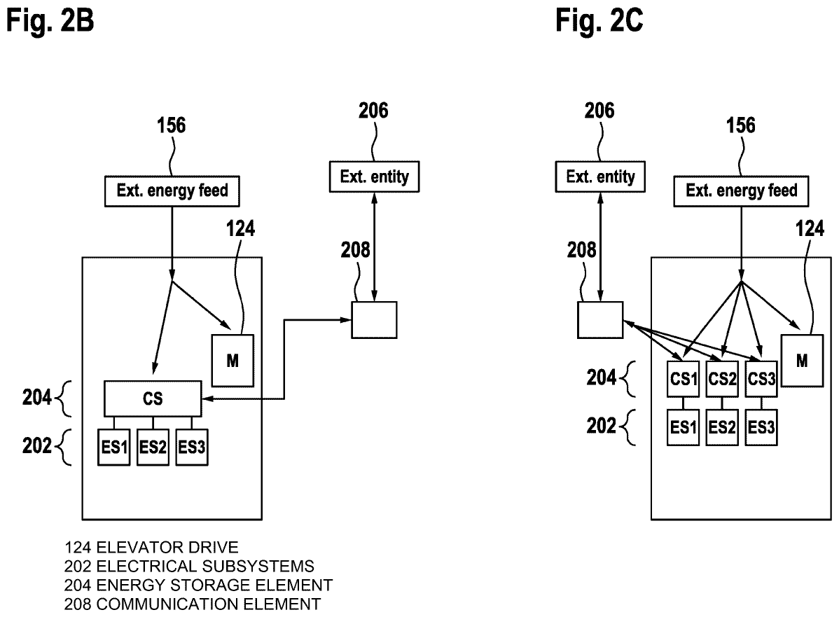

Now referring to FIGS. 2A to 2C, where different connection scenarios of electrical systems within an elevator system according to the present disclosure are depicted.

FIG. 2A is depicting an elevator installation having a common arrangement of elevator drive 124 and a plurality of electrical subsystems 202, in FIG. 2A exemplarily three electrical subsystems ES1, ES2 and ES3. Electrical energy to the elevator system is provided by an external electrical energy feed 156, which is connected to both the elevator drive 124 and each of the electrical subsystems 202. The specific type of electrical connection, e.g., three phase or one phase energy feed, is not depicted in FIG. 2A. Each of the electrical subsystems 202 can be one of the regular subsystems of an elevator system, e.g., ES1 may be the elevator controller 146, ES2 may be the light system of the elevator system and ES3 may be an emergency evacuation system or an emergency communication system of the elevator system. It is, of course conceivable that the elevator system depicted in FIG. 2A comprises more or less than the three electrical subsystems depicted.

The elevator system of FIG. 2A essentially is always connected to the electrical energy feed 156 and is able to only draw electrical energy in accordance with a current operation scenario. In other words, during a standby operation, the elevator system essentially constantly draws electrical energy required for the continuous operation of the electrical subsystems 202, and additionally electrical energy for the elevator drive 124 in case the transport function of the elevator system is in demand.

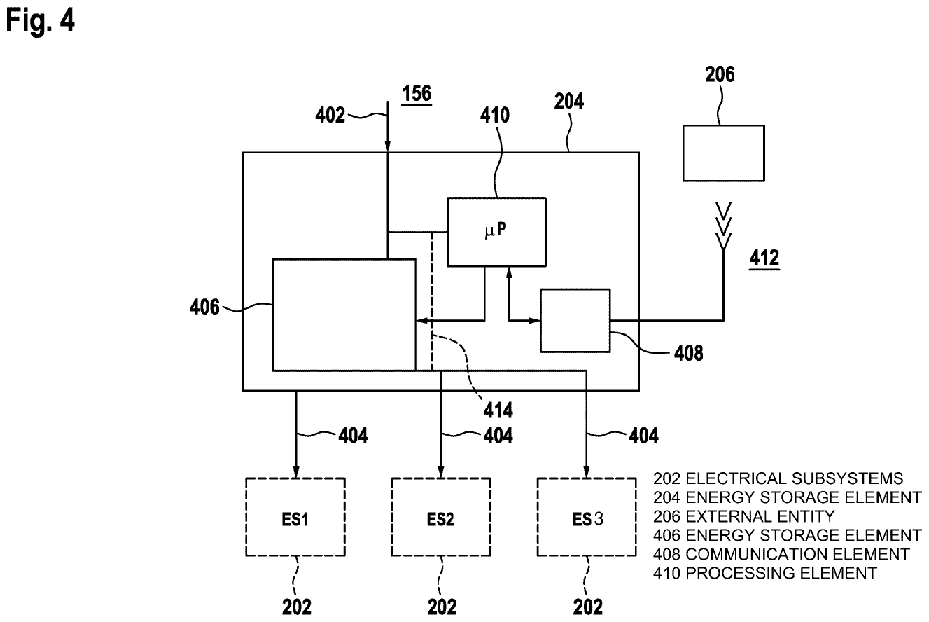

The elevator system of FIG. 2B essentially compares to the elevator system of FIG. 2A, with the exception that the three electrical subsystems 202 are not directly connected to the external energy feed 156. Rather, the three electrical subsystems 202 are connected to one connected energy storage element 204, which in turn is connected to the electrical energy feed 156. The connected energy storage element 204 is further described in relation to FIG. 4.

FIG. 2B shows that the external energy feed 156 is connected to both the elevator drive 124 and the connected energy storage element 204; the elevator drive 124 is thus directly powered by the external energy feed 156 as is the connected energy storage element 204. The electrical subsystems 202 of the elevator system of FIG. 2B however are not directly connected to the external energy feed 156, but receive the energy required for their operation via the connected energy storage element 204. In other words, connected energy storage element 204 controls the provision of electrical energy to the electrical subsystems 202. Connected energy storage element 204 may thus power one, a subset or all of the electrical subsystems 202, depending on the current control scenario. A communication element 208, in communicative connection with an external entity 206, is providing information and/or instructions to connected energy storage element 204. The control behavior of the connected energy storage element 204 may thus depend on the received instructions and/or information. Communication element 208 may also be referred to as an loT element (Internet of Things) or IoT communication element 208 and may be in communicative connection with the communication element 408 (see FIG. 4) of the connected energy storage element 204. Alternatively, or additionally, communication element 208 may also be in communicative connection with further electrical subsystems, e.g., with the elevator controller. Still further alternatively, or additionally, the communication element 208 could be the integrated into the connected energy storage element, and supplement or replace its communication element 408.

Elevator system of FIG. 2C essentially corresponds to the system of FIG. 2B, with the difference that a plurality of connected energy storage elements 204 are provided in the elevator system of FIG. 2C. Exemplarily, three connected energy storage elements 204 are provided in the elevator system of FIG. 2C, each of which is connected to one electrical subsystem 202. Every connected energy storage element 204 with its respective communication element 408 (see FIG. 4) is communicatively connected with communication element 208, which in turn is communicatively connected with external entity 206. Information and/or instructions received via the communication connections from communication element 208 may access or initiate a different control behavior of the respective three connected energy storage elements 204. In other words, while one connected energy storage elements 204 may be instructed to deactivate its connected electrical subsystem 202, one or both of the other connected energy storage elements 204 may be instructed to power its respective electrical subsystem 202. Likewise, each connected energy storage element 204 may be instructed independently from the other connected energy storage elements 204 whether to charge, not charge or discharge its respective energy storage element 406 (see FIG. 4).

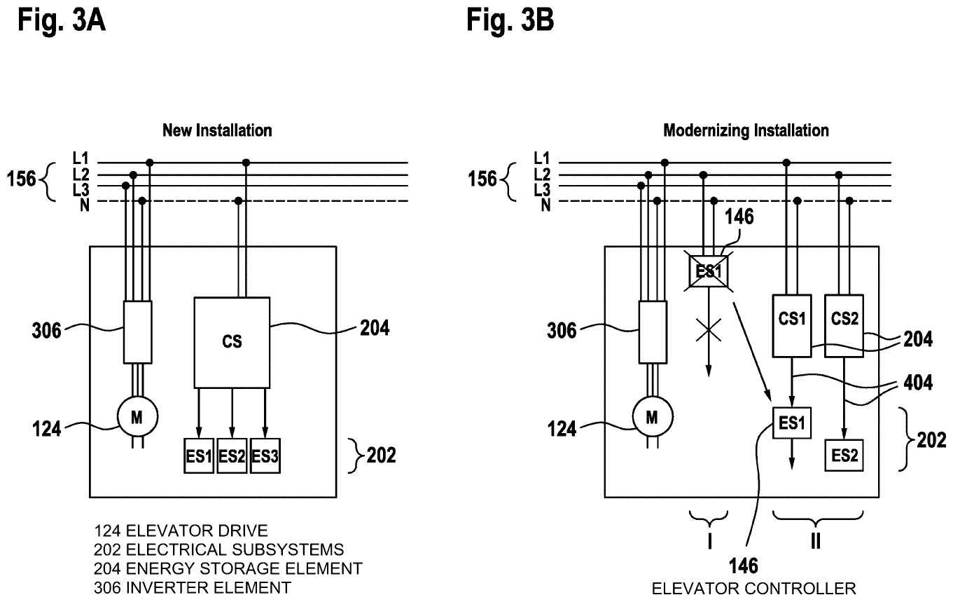

Now referring to FIGS. 3A to 3B, where different installation scenarios of connected energy storage elements according to the present disclosure are depicted.

FIG. 3A shows an elevator system where a connected energy storage element 204 in accordance with the present disclosure is installed with the new elevator system, i.e., where a connected energy storage element 204 is installed when the elevator system is mounted for the first time within the building. In FIG. 3A, the elevator drive 124 is connected to external electrical feed 156 via a three-phase electrical connection. An inverter element 306 is provided between the external electrical feed 156 and elevator drive 124, however its function is not further described in the context of the present disclosure. Parallel to the elevator drive, a connected energy storage element 204 is connected to the same external electrical feed 156 however, only using a single phase of the three-phase connection 156. The connected energy storage element 204 again exemplarily supplies energy to three electrical subsystems 202.

FIG. 3B shows the modernizing of an existing elevator installation. The elevator installation of FIG. 3B again comprises an elevator drive 124 connected via an inverter element 306 to a three-phase external electrical energy feed 156. Depicted with stage I is the elevator controller 146 prior to the modernizing. The elevator controller 146 is connected to the external electrical feed 156 via one phase and is providing control functionality downstream as depicted by the large downward arrow. As depicted under stage I by the “crossed-out” symbol, the elevator controller 156 is disconnected from the external electrical feed 156. Rather, as depicted under stage II, exemplarily two connected energy storage elements 204 are installed in the elevator installation during the modernizing process. It is of course conceivable that only one or more than two connected energy storage elements 204 are installed in the elevator installation during the modernizing process. The elevator controller 146 in turn is connected to the outlet 404 of the first connected energy storage element CS1 204 and may essentially maintain its usual functionality as prior to the modernization. In particular, all normal elements that have been controlled by the elevator controller 146 prior to the modernization may be controlled in a comparable manner in the scenario of stage II. Elevator controller 146 is thus an electrical subsystem 202 as seen by the connected energy storage element 204.

FIG. 3B is exemplarily provided with a second connected energy storage element 204 CS2, to which further electrical subsystems 202 can be connected. In FIG. 3B, CS2 exemplarily feeds a single further subsystem 202, e.g., the light system of the elevator installation. As can be seen, the installation of one or a plurality of connected energy storage elements in an existing elevator installation during modernization may be considered completely transparent as far as the elements of the existing elevator installation are concerned. The provision of connected energy storage elements 204 during modernization at the functionality of a controlled activation or deactivation of select electrical subsystems as well as the controlled powering of the electrical subsystems from either the external electrical feed 156 or the energy storage elements of the connected energy storage elements 204. Thereby, the energy consumption of the elevator system may be raised or lowered by the connected energy storage element or elements 204.

Now referring to FIG. 4 where a connected energy storage element according to the present disclosure is shown.

Connected energy storage element 204 comprises an inlet 402 for electrical energy, which is connected to the external electrical feed 156. The connected energy storage element 204 comprises exemplarily three outlets 404 for electrical energy, e.g., for connecting with electrical subsystems 202. The connected energy storage element 204 comprises an energy storage element 406, e.g., a battery, a capacitor or a super capacitor that is arranged for storing electrical energy received from the inlet 402 and thus the external electrical feed 156. Energy storage element 406 is connected to the outlets 404 for providing electrical energy stored within the energy storage element 406 to consumers connected to the outlets 404.

Connected energy storage element 204 comprises a processing element 410, arranged for controlling the operation of the connected energy storage element 204. E.g., the processing element 410 may control the energy storage element 406 regarding its input and output of electrical energy, or in other words the charging or discharging of electrical energy from the energy storage element 406. The processing element 410 may assess control whether the energy storage element 406 is charged from the external electrical feed 156 and/or whether the energy storage element 406 provides electrical energy via the outlets 404 to the consumers, e.g., the electrical subsystems 202.

Connected energy storage element 204 comprises a communication element 408 which is arranged for receiving information and/or instructions from an external entity via a communication connection 412. The communication connection may be a wired communication connection or, as depicted in FIG. 4, may be a wireless communication connection. The received information and/or instructions may instruct the processing element 410 whether to receive energy from the external electrical feed 156 and thus charge the energy storage element 406 and/or provide energy directly to the electrical subsystems 202 via bypass 414. The received information and/or instructions may, alternatively or additionally, instruct the processing element 410 whether to provide energy to one, a subgroup or all electrical subsystems 202.

Communication element 408 may also be arranged to communicate information from the connected energy storage element 204 to an external entity 206. That information may e.g., comprise information whether the connected energy storage element 204 or the elevator system where the connected energy element is arranged in utilizes electrical energy received from the external electrical feed 156 and/or whether electrical subsystems 202 are powered via energy storage element 406 and no electrical energy is taken from the external electrical feed 156.

Connected energy storage element 204 may comprise a bypass 414, which may or may not be controlled by processing element 410, so that energy received from the external electrical feed 156 may be provided directly to the outlets 404, bypassing the energy storage element 406.

It is to be understood that the invention is not limited to the embodiments described above, and various modifications and improvements may be made without deviating from the concepts described here. Any of the features described above and below may be used separately or in combination with any other features described herein, provided they are not mutually exclusive, and the disclosure extends to and includes all combinations and sub-combinations of one or more features described herein.

Finally, it should be noted that the term “comprising” not exclude other elements or steps, and that “a” or “one” does not exclude the plural. Elements that are described in relation to different types of embodiments can be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE NUMERALS

100 elevator system
112 elevator car
114 counterweight
116 traction and suspension medium
122 traction sheave
124 elevator drive
146 elevator controller
152, 154 fixed attachment
156 main power supply/external electrical feed
202 electrical subsystem
204 connected energy storage element
206 external entity
208 communication/loT element
302 elevator shaft
304 wall
306 inverter element
402 inlet for electrical energy
404 outlet for electrical energy
406 energy storage element
408 communication element
410 processing element
412 communication connection
414 bypass

1-15. (canceled)

16. A connected energy storage element for powering an electrical subsystem of an elevator system, the connected energy storage element comprising:
an energy storage element and a communication element;
wherein the connected energy storage element is adapted to connect to an external electrical energy feed and to the electrical subsystem of the elevator system;
wherein the communication element is adapted to receive information and/or instructions for controlling at least one of whether the electrical subsystem is to be powered by the external electrical energy feed, by the energy storage element or by both the external electrical energy feed and the energy storage element, and charging of the energy storage element by the external electrical energy feed; and
wherein an elevator drive of the elevator system is not powerable by the energy storage element, and/or wherein the elevator drive is not connected to the connected energy storage element.

17. The connected energy storage element according to claim 16 wherein the elevator system includes another electrical subsystem that is adapted to be powered by at least one of the external electrical energy feed and the energy storage element.

18. The connected energy storage element according to claim 16 wherein the electrical subsystem is one of an elevator controller, a light subsystem, a communications subsystem, an evacuation subsystem, an emergency communications subsystem, a door control subsystem, a door operations subsystem, a sensor arrangement, an elevator fixture, a landing operation panel, a car operation panel, a safety circuit, a pneumatic element and a pneumatic valve.

19. The connected energy storage element according to claim 16 being adapted to determine whether the external electrical energy feed is sufficient to operate an elevator drive of the elevator system, wherein when the external electrical energy feed is determined not sufficient to operate the elevator drive, the connected energy storage element inactivates the electrical subsystem, and/or when the external electrical energy feed is determined sufficient to operate the elevator drive, the connected energy storage element activates or keeps activated the electrical subsystem.

20. The connected energy storage element according to claim 19 wherein the electrical subsystem is one of an elevator controller, a light subsystem, a communications subsystem, an evacuation subsystem, an emergency communications subsystem, a door control subsystem, a door operations subsystem, a sensor arrangement, an elevator fixture, a landing operation panel, a car operation panel, a safety circuit, a pneumatic element and a pneumatic valve.

21. The connected energy storage element according to claim 16 wherein the information and/or instructions are received by the communication element from a power grid operating entity and/or a crowd balancing platform that are arranged external from the elevator system.

22. The connected energy storage element according to claim 16 wherein the information and/or instructions are indicative of and/or dependent on a current energy cost, a current energy availability, an expected future energy cost, and/or an expected future energy availability.

23. The connected energy storage element according to claim 16 wherein the information and/or instructions instruct the connected energy storage element to perform a function at a defined time in the future and/or the connected energy storage element employs the information and/or instructions to perform a function at a defined time in the future.

24. The connected energy storage element according to claim 16 wherein, based on the information and/or instructions, the connected energy storage element adjusts a current power consumption of at least a part of the elevator system.

25. The connected energy storage element according to claim 16 wherein the connected energy storage element adjusts a current power consumption of the elevator system by controlling whether the electrical subsystem is powered by the external electrical energy feed or the energy storage element or both, and/or by controlling the charging of the energy storage element by the external electrical energy feed.

26. The connected energy storage element according to claim 16 wherein the connected energy storage element reports a current energy consumption, a future energy consumption, a current energy savings and/or a future energy savings to an entity arranged external from the elevator system.

27. The connected energy storage element according to claim 16 wherein the external electrical energy feed is at least one of a power grid feed, a single-phase electrical energy feed, a local electrical energy feed and a renewable energy powered energy feed.

28. An elevator system comprising:
an elevator car moveable in an elevator shaft by an elevator drive;
an electrical subsystem adapted to operate and/or control operation of at least a part of the elevator system; and
a connected energy storage element according to claim 16 wherein the electrical subsystem is powered by at least one of an external electrical energy feed and the connected energy storage element.

29. The elevator system according to claim 28 wherein the elevator drive is not connected to the connected energy storage element, and/or wherein the elevator drive and the connected energy storage element are connected to the external electrical feed in parallel.

30. An elevator installation comprising:
a plurality of the elevator system according to claim 28, the elevator systems being arranged at a plurality of locally and/or geographically distributed operation locations; and
the elevator systems adapted to operate to
adjust an energy demand of at least a subset of the elevator systems based on the received instructions,
adjust, based on the received instructions, a current power consumption and/or a future power consumption of at least one of the elevator systems of the subset, and/or
adjust, by connecting the electrical subsystem to and/or disconnecting the electrical subsystem from the external electrical energy feed a current power consumption and/or a future power consumption of at least one of the elevator systems of the subset.

31. A method of modernizing an elevator system, the method comprising the steps of;
adding the connected energy storage element according to claim 16 to the elevator system; and
connecting the connected energy storage element to an external electrical energy feed and to the electrical subsystem of the elevator system.

32. A method of operating an elevator system and/or an elevator installation, wherein the elevator system and/or an elevator installation includes an elevator drive and an electrical subsystem, the method comprising the steps of:
providing the connected energy storage element according to claim 16;
receiving information and/or instructions via the communication element of the connected energy storage element;
dependent on the received information and/or instructions controlling whether the electrical subsystem is powered by an external electrical energy feed or by the energy storage element of the connected energy storage element, or by both, and/or controlling charging of the energy storage element by the external electrical energy feed;
wherein the elevator drive is not powerable by the energy storage element;
when the external electrical energy feed is insufficient to operate the elevator drive, inactivating the electrical subsystem; and/or
when the external electrical energy feed is sufficient to operate the elevator drive, activating or keeping activated the electrical subsystem.

33. The method according to claim 32 including reporting a current energy consumption, a future energy consumption, a current energy savings and/or a future energy savings to an entity arranged external from the elevator system and/or elevator installation.

34. The method according to claim 33 wherein the entity is a power grid operating entity and/or a crowd balancing platform.

35. The method according to claim 32 including, dependent on the received information and/or instructions, exclusively powering the electrical subsystem at a defined future point in time from the energy storage element, and/or charging at a defined future point in time the energy storage element.
